(19) United States
(12) Patent Application Publication
(10) Pub. No.: US 2010/0114341 A1
(43) Pub. Date: May 6, 2010

(54) SYSTEM AND METHOD FOR CONTROLLING ELECTRONIC DEVICES

(75) Inventor: LI-RONG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/333,654

(22) Filed: Dec. 12, 2008

(30) Foreign Application Priority Data
Nov. 3, 2008 (CN) 200810305372.X

(51) Int. Cl. G05B 15/02; G05B 11/01; G06F 17/00

(52) U.S. Cl. 700/94; 700/11; 700/90; 700/278

(57) ABSTRACT

An electronic device controlling system for a home includes a data processing center, and at least a detector connecting to the data processing center. The detector sends detected signals to the data processing center. The data processing center sends control signals to control at least one electronic device according to the detected signals. A method for controlling electronic devices is also disclosed.

### BACKGROUND

1. Technical Field

The present disclosure relates to a system and method for intelligently controlling electronic devices.

2. Description of Related Art

Electronic devices, such as computers, television sets, mobile phones, and air conditioners, are widely used in a typical home. However, remembering how to control each of the electronic devices is troublesome and inconvenient. Therefore, a system and method for intelligently controlling electronic devices is provided.

### BRIEF DESCRIPTION OF THE DRAWINGS

FIG. 1 is a block diagram of an embodiment of an electronic device controlling system for a home; and

FIG. 2 is a flow chart of an embodiment of a method for controlling electronic devices.

### DETAILED DESCRIPTION OF THE EMBODIMENTS

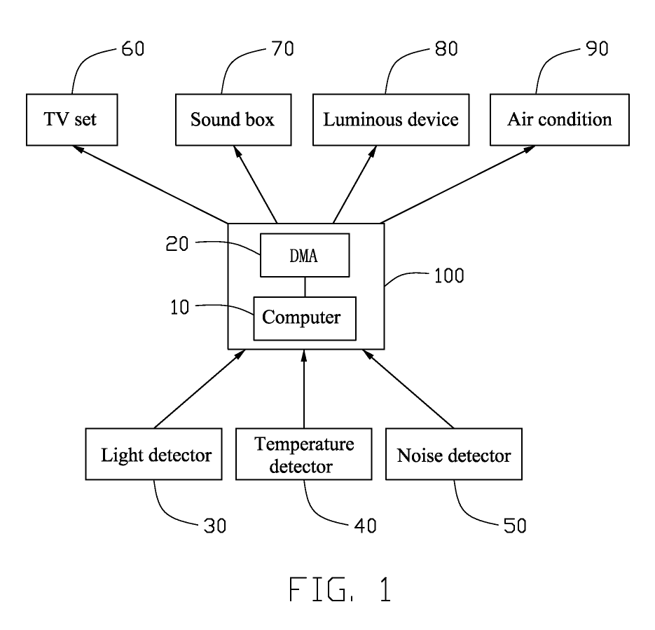

Referring to FIG. 1, an embodiment of an electronic device controlling system for a home includes a data processing center 100, a light detector 30 connected to the data processing center 100, a temperature detector 40 connected to the data processing center 100, a noise detector 50 connected to the data processing center 100, and a plurality of electronic devices. In the illustrated embodiment, for conveniently illustrating the electronic device controlling system for the home, the electronic devices includes a television (TV) set 60, a sound box 70, a luminous device 80, and an air conditioner 90. The data processing center 100 includes a computer and a Digital Media Adapter (DMA) 20. The computer 10 communicates with the electronic devices via the DMA 20.

The light detector 30 detects an intensity of ambient light both inside and outside of the home, and sends light data to the data processing center 100.

The temperature detector 40 detects ambient temperature inside the home, and sends temperature data to the data processing center 100.

The noise detector 50 detects noise inside or outside of the home, and sends noise data to the data processing center 100.

The data processing center 100 processes the data from the detectors 30, 40, 50 by comparing the data with predetermined parameters, and then sending control signals to control the electronic devices in the home accordingly.

In one embodiment, when a user is inside the home, the user may operate a power switch installed, for example, near a doorway, to power on the data processing center 100 and the detectors 30, 40, 50. The data processing center 100 may send control signals to switch the luminous device 80 on or off according to the light intensity detected by the light detector 30, to switch on or off the air conditioner 90 and further regulate the current temperature setting of the air conditioner 90 according to the temperature data from the temperature detector 40, and to change the volume of the TV set 60 and the sound box 70 according to the noise data from the noise detector 50. The user may also operate the power switch again to power off the data processing center 100 which sends signals to power off the electronic devices. If the user desires to control the electronic devices manually instead of utilizing the data processing center 100, the controlling function of the data processing center 100 may be disabled.

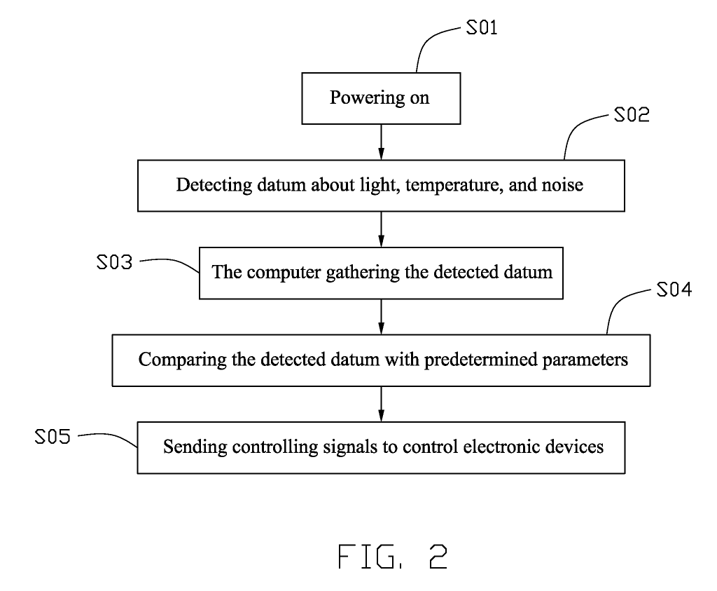

Referring to FIG. 2, an embodiment of a method utilizing the electronic device controlling system for a home includes steps of:

S01: powering on the data processing center 100 and the detectors 30, 40, and 50;

S02: measuring levels of light, temperature, and noise from the light detector 30, the temperature detector 40, and the noise detector 50, respectively;

S03: receiving data from the detectors;

S04: comparing the data with predetermined parameters, for example, comparing the light intensity detected by the light detector 30 with a predetermined light intensity, comparing the temperature detected by the temperature detector 40 with a predetermined temperature, and comparing the volume of the noise detected by the noise detector 50 with a predetermined volume;

S05: sending control signals to control the electronic devices, for example, when the light intensity detected by the light detector 30 is lower than the predetermined light intensity and it is dark outside, the luminous device 80 is turned on; when the temperature detected by the temperature detector 40 is higher or lower than the predetermined temperature, the air conditioner 90 is turned on or off accordingly; when the noise level detected by the noise detector 50 exceeds a predetermined noise level, the volume of the TV set 60 and the volume of the sound box 70 is turned up.

It is to be understood, however, that even though numerous characteristics and advantages of the present disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. An electronic device controlling system for a home, the system comprising a data processing center and at least one detector connected to the data processing center, wherein the at least one detector sends detected signals to the data processing center; the data processing center sends control signals to control at least one electronic device according to the detected signals.

2. The system of claim 1, wherein the data processing center comprises a computer and a digital media adapter; the computer communicates with the electronic device via the digital media adapter.

3. The system of claim 1, wherein the at least one electronic device comprises a luminous device; the at least one detector is a light detector detecting a light intensity inside the home and sending light intensity data to the data processing center; the data processing center sends control signals to switch the luminous device on or off.

4. The system of claim 1, wherein the at least one electronic devices comprises an air conditioner; the at least one detector is a temperature detector detecting an ambient temperature and sending temperature data to the data processing center; the data processing center sends control signals to control the air conditioner according to the temperature data.

5. The system of claim 1, wherein the at least one electronic devices comprises a TV set and a sound box; the at least one detector is a noise detector detecting noise and sending noise data to the data processing center; the data processing center changes the volume of the TV set and the volume of the sound box according to the noise data.

6. A method for controlling electronic devices, the method comprising:
connecting electronic devices and detectors to a data processing center;
detecting signals;
gathering the signals;
comparing the signals with predetermined parameters; and
sending control signals to the electronic devices to control the electronic devices.

7. The method of claim 6, wherein the step of detecting comprises detecting light intensity, detecting temperature, and detecting noise.

8. The method of claim 7, wherein the step of gathering comprises gathering the light intensity, gathering the temperature, and gathering the noise.

9. The method of claim 8, wherein the step of sending control signals to control the electronic devices comprises switching a luminous device on or off, controlling a temperature setting of an air conditioner, and changing the volume of a TV set and the volume of a sound box.

10. The method of claim 6, wherein the data processing center comprises a computer and a digital media adapter; the computer communicates with the electronic devices via the digital media adapter.
